(19) United States
(12) Patent Application Publication
(10) Pub. No.: US 2009/0271869 A1
(43) Pub. Date: Oct. 29, 2009

(54) Process for Establishing a System Licensing Internal Code Table

(75) Inventor: CHUN-FU CHAN, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/399,115

(22) Filed: Mar. 6, 2009

(30) Foreign Application Priority Data
Mar. 28, 2008 (TW) 97111428

(51) Int. Cl. G06F 9/00; G06F 21/00

(52) U.S. Cl. 726/26; 713/2

(57) ABSTRACT

A process for establishing a system licensing internal code table used in a basic input/output system is disclosed, in which the basic input/output system includes a system control module. According to the process, the system-locked pre-installation location of the system control module is determined whether it stores the identifying data. If the identifying data is stored in the system-locked pre-installation location, the identifying data is determined whether it is the pre-determined data. The system licensing internal code table is established if the identifying data is not the pre-determined data.

### RELATED APPLICATIONS

This application claims priority to Taiwan Application Serial Number 97111428, filed Mar. 28, 2008, which is herein incorporated by reference.

### BACKGROUND

1. Field of Invention

The present invention relates to a process for establishing a system licensing internal code table. More particularly, the present invention relates to a process for establishing a system licensing internal code table in a basic input/output system.

2. Description of Related Art

Computer software piracy problem is becoming increasingly serious as software develops. When it comes to the operating system, the piracy problem is getting even worse. The most known is that the verifying information of the operating system can be grabbed through the OEM (Original equipment manufacturer; OEM).

Once the motherboard has been booted, the basic input/output system software is authorized to establish a system licensing internal code table (SLIC table), read out the verification information from the basic input/output system, and put the verification information into the SLIC table. Then, the operating system compares the verification information based on the SLIC table. If the verification information is matched, this operating system is able to be used by the motherboard.

However, if the motherboard without the verification information can grab the verification information from the non-protected motherboard which has the verification information, and establish the SLIC table with the grabbed verification information, the operating system will mistakenly identify the non-genuine motherboard, and is able to be used by the motherboard. As a result, the operating system vendors endure huge losses.

Therefore, a new SLIC table establishing sequence which can protect the verification information from been grabbed is required.

### SUMMARY

According to one embodiment of the present invention, a process for establishing a system licensing internal code table used in a basic input/output system is disclosed, in which the basic input/output system includes a system control module. According to the process, a system-locked pre-installation location of the system control module is determined whether it stores the identifying data. If the identifying data is stored in the system-locked pre-installation location, the identifying data is determined whether it is equal to the pre-determined data. The system licensing internal code table is established if the identifying data is not the pre-determined data.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the flowchart for establishing the system licensing internal code table according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

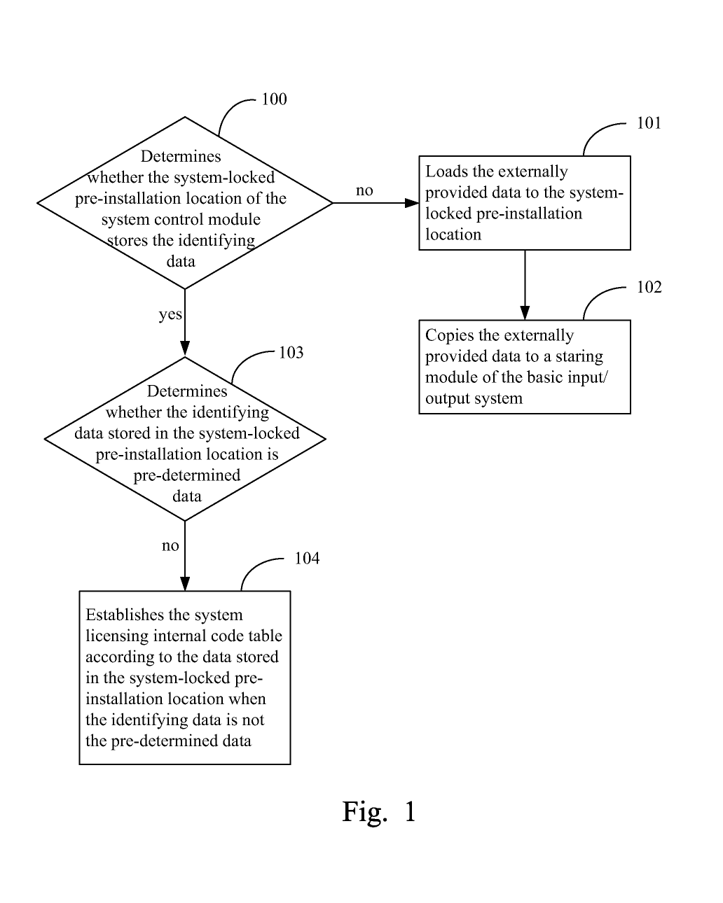

FIG. 1 shows the flowchart for establishing the system licensing internal code table according to one embodiment of the present invention. The system licensing internal code table is adapted in the basic input/output system. The basic input/output system includes a system control module (nonvolatile random access memory, Nvram). Step 100 determines whether the system-locked pre-installation location of the system control module stores the identifying data. In this embodiment, the identifying data is compared with FFFF to determine whether the identifying data is stored in the system-locked pre-installation location. If the identifying data is equal to 0xFFFF, then the identifying data does not exist in the system-locked pre-installation location, which means that the basic input/output system has not been started after the basic input/output system had been manufactured; on the other hand, if the identifying data is not equal to 0xFFFF, then the basic input/output system has been started once and has been written with data.

If step 100 determines that the system-locked pre-installation location doesn't store the identifying data (in the case that data stored in the system-locked pre-installation location is equal to 0xFFFF), step 101 is performed to execute a pre-determined program to load externally provided data to the system-locked pre-installation location. The externally provided data determines if the motherboard with the basic input/output system has the ownership of the operating system. After step 101, step 102 is performed to copy the externally provided data to a staring module of the basic input/output system.

On the other hand, if step 100 determines that the system-locked pre-installation location stores the identifying data (data stored in the system-locked pre-installation location is not equal to 0xFFFF), step 103 is performed to determine whether the identifying data is the pre-determined data. In this embodiment, the identifying data stored in the system-locked pre-installation location is compared with 0000 to determine whether the identifying data is the pre-determined data. If the identifying data is equal to 0000, the operating system identifies the motherboard with the basic input/output system doesn't have ownership of the operating system; on the other hand, if the identifying data is not equal to 0000, the operating system identifies if the motherboard with the basic input/output system owns the operating system, and the identifying data is used for verifying/identifying (step 104).

Therefore, if the identifying data is not the pre-determined data (not equal to 0000), then the system licensing internal code table is established, and the operating system verifies if the motherboard owns the operating system according to the system licensing internal code table.

The embodiment of the present invention loads the identifying data stored somewhere else the system-locked pre-installation location in the basic input/output system to the system-locked pre-installation location and records the loading sequence when the motherboard is started for the first time. When the motherboard is started again, the basic input/output system establishes the system licensing internal code table according to the identifying data stored in the system-locked pre-installation location, in which the system licensing internal code table is verified by the operating system.

Except the first time the motherboard is started, data can hardly be written into the system control module section where the system-locked pre-installation location located in, therefore only the motherboard with the identifying data written into its system-locked pre-installation location when the motherboard is started for the first time can establish the system licensing internal code table.

The motherboard without the identifying data stored in the system control module section can't grab the identifying data and affect the identification process made by the operating system, which prevents the piracy problem.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A process for establishing a system licensing internal code table used in a basic input/output system, wherein the basic input/output system comprises a system control module (Nvram), the process comprising:
determining whether a system-locked pre-installation location of the system control module stores identifying data;
determining whether the identifying data is pre-determined data when the identifying data is stored in the system-locked pre-installation location; and
establishing a system licensing internal code table when the identifying data is not the pre-determined data.

2. The process for establishing the system licensing internal code table as claimed in claim 1, wherein the identifying data is compared with 0xFFFF to determine whether the identifying data is stored in the system-locked pre-installation location.

3. The process for establishing the system licensing internal code table as claimed in claim 1, further comprising executing a pre-determined program to load externally provided data to the system-locked pre-installation location when the identifying data is not stored in the system-locked pre-installation location.

4. The process for establishing the system licensing internal code table as claimed in claim 3, further comprising copying the externally provided data to a staring module of the basic input/output system after the externally provided data is loaded to the system-locked pre-installation location by the pre-determined program.

5. The process for establishing the system licensing internal code table as claimed in claim 1, wherein the identifying data stored in the system-locked pre-installation location is compared with 0000 to determine whether the identifying data is the pre-determined data.
